(19) United States
(12) Patent Application Publication
(10) Pub. No.: US 2019/0240103 A1
(43) Pub. Date: Aug. 8, 2019

(54) Exoskeletal gait rehabilitation device

(71) Applicant: Bionic Power Inc., Vancouver (CA)

(72) Inventors: Daniel Loren Hepler, Vancouver (CA); Clive Edward Mullins, North Vancouver (CA)

(21) Appl. No.: 15/981,100

(22) Filed: May 16, 2018

Related U.S. Application Data
(60) Provisional application No. 62/625,734, filed on Feb. 2, 2018.

(51) Int. Cl. A61H 3/00; A61H 1/02

(52) U.S. Cl. CPC A61H 3/00; A61H 1/024; A61H 2003/007; A61H 2201/165; A61H 2201/1207; A61H 2201/1676; A61H 2201/5007; A61H 2201/164; A61H 2205/088; A61H 2230/085; A61H 2230/625; A61H 2201/5069

(57) ABSTRACT

A powered exoskeletal device is worn by a patient with a walking disorder. Baseline measurements of the patient's gait are made with the device, and a torque profile for providing assistance to the patient is selected based on the particular patient's baseline. Throughout rehabilitation, a gait quality metric is monitored and adjustments are made to the torque profile accordingly.

### FIELD OF THE INVENTION

This application relates to the field of exoskeletons used to assist walking motion. More specifically, this application relates to the customization of assistance depending on a determination of a patient's gait disorder, specific baseline gait and rehabilitation target.

### BACKGROUND OF THE INVENTION

Human gait is highly challenging to understand and assess because of the large number of various mechanical movements involved. For example, the knee moves in a complex rolling motion rather than as a simple hinge. Assistive equipment can be used to improve the physical condition of individuals who are affected by movement disorder diseases such as cerebral palsy, or to help people who need physical rehabilitation. Mechanical apparatus involved in this kind of bio-medical equipment usually comprises actuation devices including electric motors, hydraulics and pneumatic components. However, hydraulics and pneumatics can raise concern about the potential hazard for the wearer if a leak occurs in the equipment.

A powered exoskeletal device (PED) is a robotic system that involves a power system for providing motorized assistance to a human body. It can also persistently alleviate knee buckling. This type of system is also able to harvest energy using the passive dynamics of walking. The principal challenge is to adjust the system to each body morphology without forming a mechanical hindrance. The major drawbacks with PEDs used for military applications and spinal cord injury are their size and weight. Indeed, heavy materials such as stainless steel and titanium are mostly used in this kind of equipment.

Proper gait analysis is essential to implement the appropriate torque feedback in a PED. An injury can be caused by the lack of appreciation of a user's gait when setting the torque to be applied by the PED. An optimization of the resistive torque applied during gait is important for the smooth functioning of the PED. In addition, a powered PED can be used to determine user intent or estimate a measurement of the gait and apply a sensitivity amplification to match the stride or the gait of the wearer.

U.S. Pat. No. 7,652,386 to Donelan et al. relates to an apparatus for harvesting energy from motion of one or more joints. In this apparatus, one or more sensors are used to sense the characteristics associated with the motion of one or more joints, and control circuitry triggers energy harvesting when the conditions during the motion are considered to be mutualistic.

U.S. Patent Application Publication 2017/0196750 to Hepler et al. discloses a device for the intermittent assistance of body segment motion. When the motion of the body segment is cyclical, for example during walking, assistance to the body segment is switched on and off throughout the cycle to correspond to positive and negative power modes respectively. Energy used to assist the body segment may be harvested from prior motion of the body segment, either in prior cycles and/or when the body segment is moving in a negative power mode.

Referring to FIG. 1, there is shown a graph to illustrate the stages in a gait cycle. Evolution of physical parameters as a function of time, in particular the angular velocity, the torque and the power during the walking motion are each depicted in a separate plot. Gait cycle 101 may generally be divided into a swing portion 104 and a stance portion 110. During the swing portion 104, the foot corresponding to the shaded knee (i.e. the right knee) is off of the ground. In the stance portion 110, the foot corresponding to the shaded knee is on the ground. Swing portion 104 may be further divided into a swing flexion portion 102, during which the shaded knee is flexing, and a swing extension portion 106, during which the shaded knee is extending. Stance portion 110 may be further divided into a stance/collision flexion portion 108, during which the knee is flexing, and a stance extension portion 112, during which the knee is extending. During one gait cycle 101, angular velocity plot 122 comprises extrema 115, 116, 118 and 120, which occur, respectively, in swing flexion portion 102, swing extension portion 106, stance/collision flexion portion 108 and stance extension portion 112. These extrema correspond to the end of acceleration of the knee joint.

Plot 126 illustrates the measurement of the knee torque as a function of time. By combining plots 122 and 126, the sign of the power mode can be inferred. In plot 136, muscles are acting to decrease the mechanical energy of the knee joint in negative power intervals 130, 132 and 134 of power plot 136. In interval 130, knee flexor muscles are acting against the extension that occurs during swing extension in order to arrest extension of the knee prior to heel strike. In interval 132, knee extensor muscles are acting against the flexion that occurs during stance/collision flexion when the mass of the human is transferred to the foot shortly after heel strike. In interval 134, knee extensor muscles are acting against the flexion that occurs during swing extension in order to arrest flexion of the knee prior to the start of swing extension. The knee is working in a positive power mode in interval 138, as it is in intervals 140, 142 and 144.

### SUMMARY OF THE INVENTION

Depending on the embodiment, one or more of the above-described problems have been reduced or eliminated, while other embodiments are directed to other improvements.

The present invention is directed to a method, device and system for assisting motion of two or more body segments separated by joints. In particular, the purpose of the device is to assist the wearer by providing assistive torque and/or generating substantial power from the motion of walking with minimal metabolic effort, and to monitor over time the assistance provided by the system while walking. The assistance provided is customized to the user's particular gait disorder and rehabilitation plan.

The exoskeletal rehabilitation device (ERD) of the present invention is attached to two or several body segments connected by joints and used to reduce fatigue during walking. The system is implemented for use with body segments that exhibit cyclical and repetitive motions such as the leg. The motion of a body segment can be described as a succession of negative and positive power modes, with an energy harvesting system taking advantage of the negative power mode in order to generate and store energy. A negative power mode exists when the angular velocity of the joint between the segments and the torque are in opposite directions. In one example case of a negative power mode, the muscles of the leg are acting as a brake at various moments during the gait.

In the present system, initial settings are selected regarding the patient's baseline profile; and data from various sensors is processed in order to match the ERD mechanical response to the motion of the body segment. Data exchange and interaction between ERDs worn on each leg are optimized in order to harmonize the overall mechanical response to the motion of the gait, which is associated with the specificities of each individual's morphology and/or needs.

Another aspect of the invention is a lightweight construction to mitigate the metabolic cost induced by wearing the ERD. Indeed, the metabolic cost is brought about by the weight of the device, which can increase the fatigue of the patient (or wearer or host) if the mechanical assistance provided by the ERD does not compensate the fatigue. The metabolic cost can be understood as the balance between the energy consumed by the body during walking and the mechanical assistance provided by the biomechanical energy harvester.

The ERD is useful for patients with cerebral palsy, including spastic hemiplegia and spastic diplegia, muscle weakness due to aging, minor paralysis due to brain or spinal cord injuries, stroke victims, multiple sclerosis, polio and muscular dystrophy. The ERD can help to make muscles stronger, reduce atrophy, or to help prevent or delay the need for a wheelchair.

In addition to the exemplary aspects and embodiments described above, further aspects and embodiments will become apparent by reference to the drawings and by a study of the following detailed description.

### BRIEF DESCRIPTION OF THE DRAWINGS

The following drawings should not be construed as restricting the scope of the invention in any way.

FIG. 1 shows prior art plots of angular velocity, torque and mechanical power, which relate to typical dynamics of a knee joint during a walking gait cycle.

FIG. 2 is a drawing that shows a right leg from the outside, equipped with an ERD, according to an embodiment of the present invention.

FIG. 3 is a drawing that shows the right leg from the front, equipped with the ERD.

FIG. 4 is a flowchart that shows how the data related to the gait of the wearer is collected by the ERD.

FIG. 5 is a flowchart that shows a specific example of how gait rehabilitation is implemented.

FIG. 6 is a flowchart of a process depicting the functioning and the optimization of the ERD settings.

FIG. 7 is a flowchart showing the control of the ERD based on detection of a muscle spasm.

FIG. 8 is a schematic diagram of an exoskeletal rehabilitation system, according to an example embodiment of the present invention.

FIG. 9 schematically depicts control logic according to a particular embodiment of the invention, which may be used as part of the exoskeletal rehabilitation system of FIG. 7.

FIG. 10 schematically depicts the setup and the interface between two exoskeletal rehabilitation systems, each coupled to a different leg.

FIG. 11 is a flowchart that shows the cooperation between two ERDs.

FIG. 12 shows graphs of performance of an embodiment of the present invention without slow speed motor control.

FIG. 13 shows graphs of performance of an embodiment of the present invention with slow speed motor control.

FIG. 14 is a drawing that shows a right leg from the front, equipped with an alternative embodiment of the ERD.

FIG. 15 shows a flowchart for controlling the ERD based on the detection of the use of crutches.

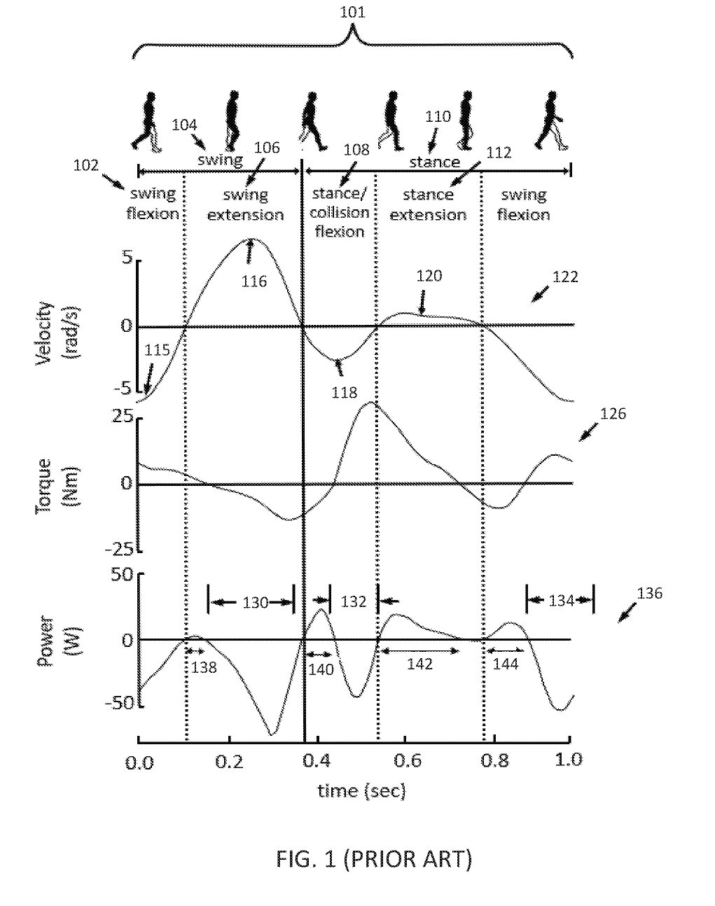

### DETAILED DESCRIPTION

### A. Glossary

The term “assistance” is used herein to refer to helping a patient walk, either in the negative power mode, the positive power mode or both.

The term “augmentation” is used to refer to the assistance to a patient involving adding torque in the same direction as the body segment is accelerating.

The term “body segment” may refer to a part of a body, such as a thigh, for example. It may also refer to one or more muscles of the body segment, such as a hamstring and a quadriceps. Further, a body segment may also comprise multiple, constituent body segments, depending on how they are defined. Most muscle groups span across two joints. For instance, the hamstring (i.e. the biceps femoris and semitendinosus) spans from pelvis to tibia, and the quadriceps (including, e.g., the vastus intermedius) spans from upper femur to tibia via the patella and tendons. As a consequence, contraction of a muscle may affect multiple skeletal body segments.

The term “harvesting” is used when the patient is being assisted in the negative power mode, i.e. when the motor-generator is generating electricity and, as a consequence, opposing the direction of motion of the body segment.

The term “lateral” refers to a position towards the left or right side of the human body.

The term “medial” refers to a position towards the center of the human body.

The term “negative power mode” refers to a situation where the knee torque and angular velocity have opposite signs.

The term “positive power mode” refers to a situation where the knee torque and angular velocity have similar signs.

The term “sensor” includes, but is not limited to, a device or module that detects events or changes in its environment and usually sends the information to other electronic devices.

The term “system” includes, but is not limited to, the constituent mechanical and electronic components of a single ERD, or a set of two ERDs working in cooperation.

The term “torque” refers to a moment of force that produces rotation or torsion, or opposes rotation or torsion.

### B. Exemplary Embodiment

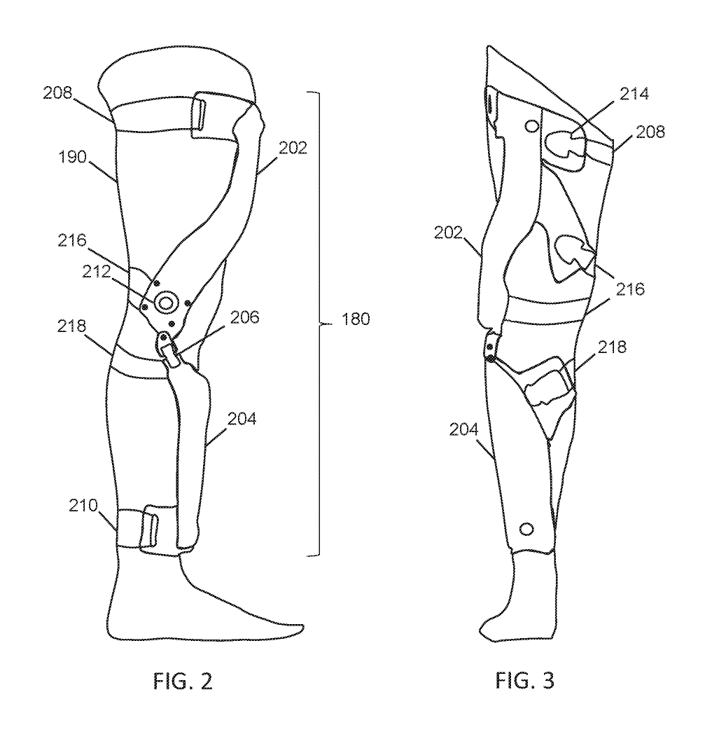

Referring to FIG. 2, detail of the representation of the ERD 180 attached to a right leg 190 is shown as seen from its right side. The device includes one upper shell 202 and one lower shell 204 connected by a complex, lateral hinged joint 206. In the illustrated embodiment, the shells 202, 204 of the ERD 180 are molded in such a manner as to closely fit the contours of the leg 190. The shells 202, 204 may be made from carbon-Kevlar™, for example, so that they are more lightweight in comparison to the use of other materials. Several straps are used to attach the shells 202, 204 of the ERD 180 to the leg 190. For example, strap 208 is used to attach the ERD 180 to the upper part of the thigh. Strap 210 attaches the lower shell 204 of the ERD 180, which covers the shin, to an area immediately above the ankle. Component 212 represents the motor generator that is positioned in the lower part of the upper shell 202 of the ERD 180, which covers the quadriceps of the thigh. Hinged joint 206, which may be a simple or complex hinge joint, can be described as a pivot point connecting the lower shell 204 to the upper shell 202 of the ERD 180. The lower shell 204 of the ERD 180 covers the shin of the leg 190.

Referring now as well to FIG. 3, clip 214 enables the user to fix and adjust the strap 208 of upper shell 202 on the upper thigh. In some embodiments, other methods to adjust the length of the straps may be used. The strap 216 has “Y” shape and is used to attach the upper shell 202 to the leg 190. The strap 218 is used to attach the lower shell 204 of the ERD 180 to the upper calf.

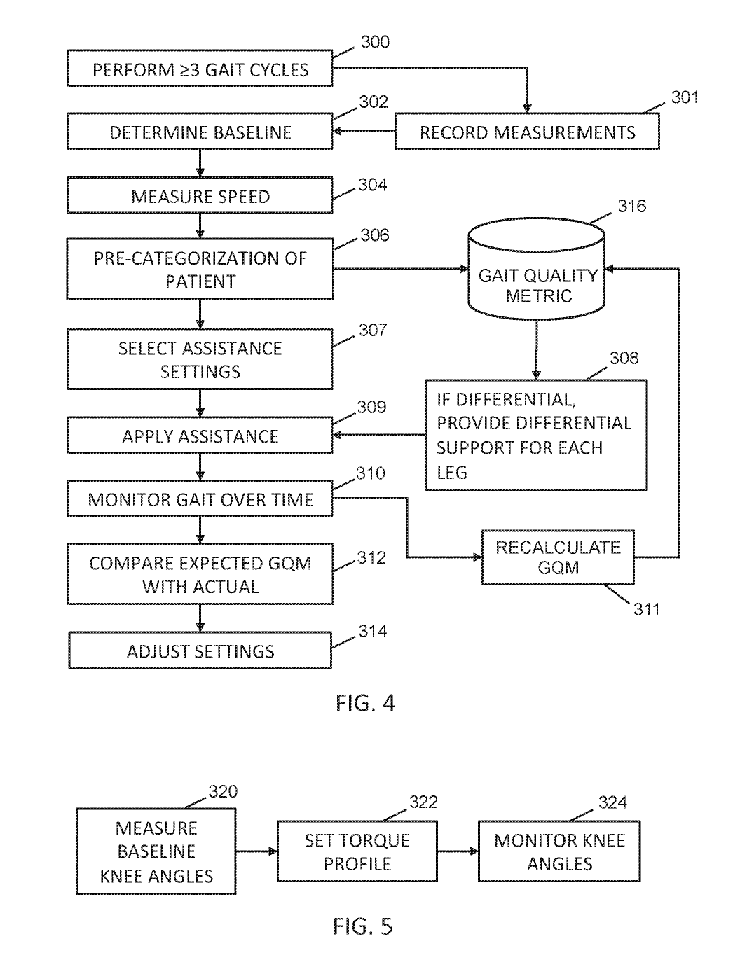

Referring to FIG. 4, a flowchart is shown of how the ERD is used. While at least three gait cycles are performed in step 300 with the patient wearing the ERD or a system of two ERDs, baseline measurements of the parameters of the patient's gait are recorded, in step 301. Based on the measurements, a baseline gait is determined in step 302. Then, in step 304 (or concurrently with step 302), the speed of the gait is measured. After that, in step 306, the patient is pre-categorized into one of several gait afflictions, such as mild, medium or severe. The pre-categorization of the gait is stored as a gait quality metric (GQM) in database 316. Selection of the assistance settings is carried out in step 307. The precise level of torque needed for the assistance can be set to challenge, but not overly exert, the patient in order to mitigate the risk of injury. Furthermore, the level and pattern of assistance is, in some embodiments, based on data collected from numerous other patients who have a similar condition and have undergone rehabilitation with the ERD.

In some embodiments, the assistance settings are selected automatically, based on a library of data of different gait disorders and severities, different ages of patients, and desired level of assistance. In other embodiments, the settings are selected by a therapist responsible for the rehabilitation of the patient. If the patient's gait suffers to different extents in each leg, as evident from the GQM, then, in step 308, the ERC control system adjusts the settings to provide differential support for each leg.

In step 309, the ERD provides assistance to the patient. Assistance includes applying augmentation to movement between the thigh and the shin during positive work phases of the patient's gait; and applying resistance to movement between the thigh and the shin during negative work phases of the patient's gait.

The system monitors the gait over time in step 310 and, from time to time, further recalculates the gait quality metric 311 and stores it in the database 316. Calculating the GQM after a period of rehabilitation may involve, for example, determining a later maximum extension of the knee as an average maximum extension over at least three cycles of the patient's gait.

In step 312, the expected GQM is compared with the actual data. The expected GQM at a given time after the start of treatment is based on the pre-categorization of the patient's gait and the assistance program selected for the patient. Depending on the rehabilitation program chosen, the expected GQM after a few weeks of treatment may be a specific increase in the maximum angular extension of the knees, for example. Based on the comparison of actual gait with expected gait, the settings are adjusted in step 314, if required. Settings may be adjusted manually, by a therapist, or automatically by the system, depending on the embodiment. Settings may be adjusted based on data collected from a group of patients with similar conditions who have already used the ERD.

Referring to FIG. 5, a diagram representing a more specific portion of FIG. 4 is provided. This shows that the monitoring of knee angles is implemented in the ERD. In step 320, the baseline for knee angles is measured. The key knee angles that are measured are, for example, the angles that represent the maximum extension of the legs in both the swing phase and the stance phase of the gait. Maximum knee angles are a key indicator for the severity of the patient's condition. Maximum knee angles in all phases of the gait may be measured in some embodiments, i.e. in the phases of swing extension, stance flexion, stance extension, and swing flexion. The angles of maximum extension are calculated as an average over at least three gait cycles. Based on the baseline measurement, the torque profile is set, in step 322, to provide the desired assistance to the patient. The torque profile includes periods of resistance in negative power modes, during which energy is harvested, and periods of augmentation in positive power modes. Over time, the knee angles are monitored, in step 324, and stored in the database 316. The monitored knee angles form part of the GQM.

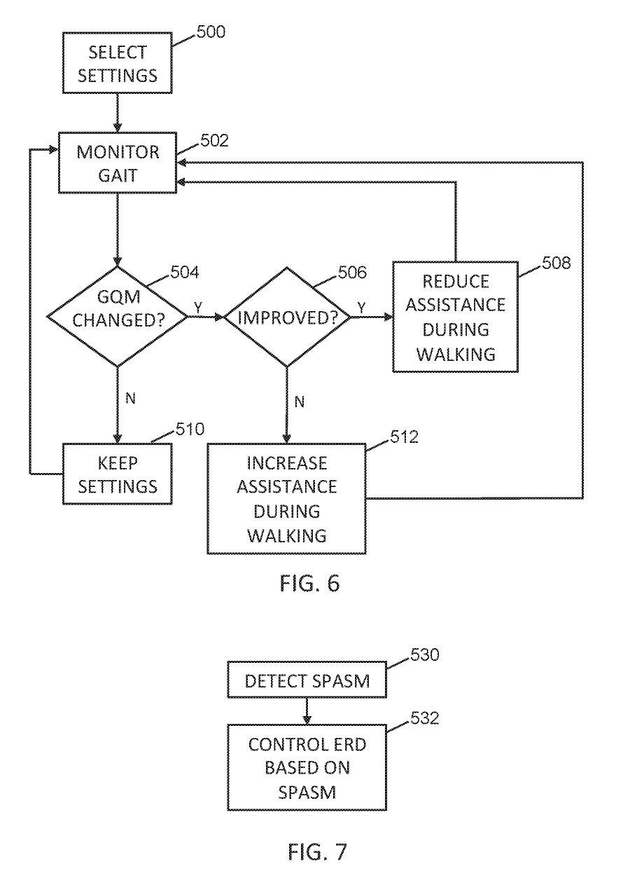

Referring to FIG. 6, an example of how the ERD is used is shown. In step 500, the settings of the ERD are selected in order to provide the assistance to the patient according to the desired rehabilitation program. The ERD system monitors the patient's gait in step 502. Some time later, for example after a few weeks, a determination is made in step 504 as to whether the GQM has changed. If the GQM has changed, then the system determines whether the gait has improved or not, in step 506. An improvement is indicated, for example, by an increase in the angle of the knee between stance flexion and stance extension, or by an increase in the speed of the gait, or by an increase in the distance the patient can walk before needing a rest. All of these may signify an increase in the muscle strength of the patient. If it is determined that the gait has improved then the assistance provided by the system is reduced in step 508, after which the system continues to monitor the gait in step 502. The change in the assistance provided may be determined in some embodiments by artificial intelligence or a neural network. If it is determined in step 506 that the gait has not improved, then assistance during walking is increased in step 512, after which the system continues to monitor the gait in step 502. Referring back to step 504, if the GQM has not changed, then the settings for the level of assistance are kept the same, in step 510, following which the system continues to monitor the gait in step 502.

The goal with cerebral palsy patients is to either increase the peak knee extension angle between swing extension and stance flexion, or to prevent deterioration so that a wheelchair is unnecessary. When the hamstrings are stretched, the nervous system lapses into spasticity, so, in one embodiment, spasms in the hamstring are detected by an electromyography (EMG) sensor. At points when the spasms are detected, the ERD extends the knee to push through the point or maintain it, desensitizing the nervous system to the stretching of the hamstring. Referring to FIG. 7, in step 530, the ERD detects that a muscle spasm is occurring in the hamstring. In step 532, the ERD is controlled based on the detection of the spasm. In other embodiments, EMG sensors are used to detect activity in other muscles, such as the quadriceps, the hip flexors, the gluteal muscles, the gastrocnemius, etc.

### C. Control

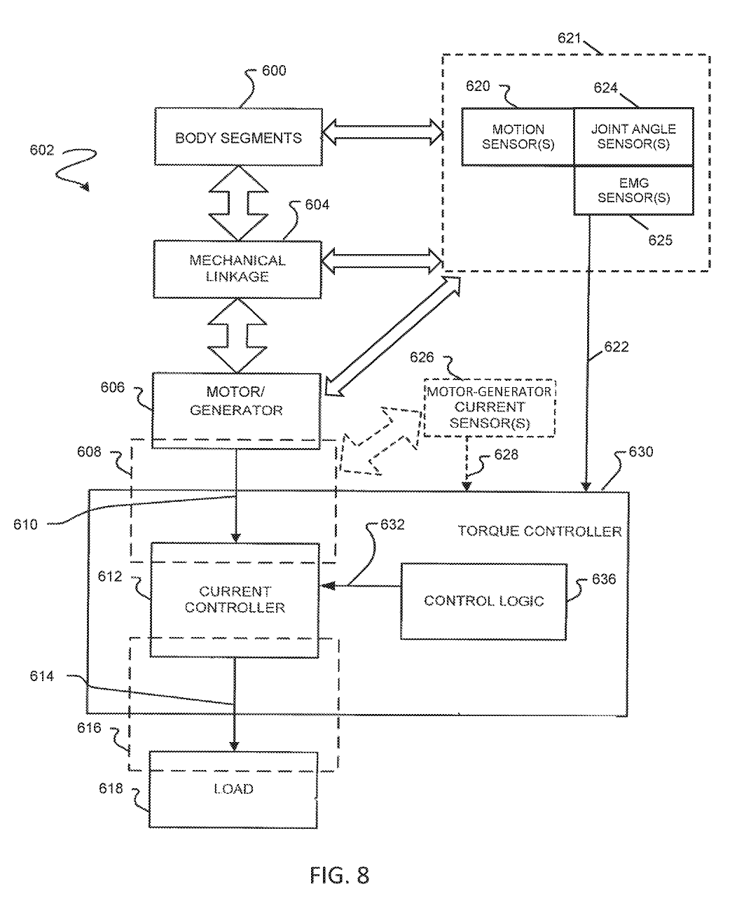

Referring to FIG. 8, a detailed example of a system 602 of components for the ERD is shown. A motor-generator 606 is coupled by a mechanical linkage 604 to two body segments 600 of the patient's leg. Motion of one or both of the body segments 600 is analyzed by sensors 621, including, for example motion sensor(s) 620, a joint angle sensor 624 (e.g. knee angle sensor) and one or more EMG sensors 625. Mechanical linkage 604 is also analyzed by sensors 621, e.g. the motion sensor(s) 620 and joint angle sensors 624. Joint angle sensors on the mechanical linkage 604 and joint angle sensors that measure the actual angle of the joint knee may provide different angles depending on the amount of slack between the body segments 600 and the mechanical linkage. Motor-generator 606 is also analyzed by the sensor(s) 621, e.g. the motion sensor(s) 620. Data gathered by the sensors 621 is transmitted to the torque controller 630 via connection 622. The motor-generator 606 is electrically connected to the torque controller 630, which controls the motor torque developed by motor-generator when operating as a motor in an augmentation mode. Torque controller 630 is electrically connected via connection 614 to an electrical load 618 (e.g. rechargeable battery) and is configured to control the supply of current from motor-generator 606 to load when the motor-generator is operating in harvesting mode. In particular embodiments, torque controller 630 comprises a current controller 612, which controls the current supplied to the motor-generator 606 and (since this current is at least approximately proportional to the motor torque) thereby controls the motor torque developed by the motor-generator 606. As an example only, the torque generated by the motor-generator is in the range 3-30 Nm, and depends on the size and weight of the patient.

In the illustrated embodiment, the torque controller 630 also comprises control logic 636. The motor-generator current sensor circuit 626 provides an electrical connection between motor-generator 606 and current controller 612. The motor-generator current sensor circuit 626 comprises an input/output connection 610 between the motor-generator 606 and the current controller 612. Connection 610 may operate as an output from the current controller 612 and an input to the motor-generator 606 when the system 602 is operating in augmentation mode. Conversely, connection 610 may operate as an output from the motor-generator 606 and an input to the current controller 612 when the system 602 is operating in energy harvesting mode. Motor-generator current sensor circuit 626 may also comprise other circuit components not expressly shown, e.g. rectifying components, amplifiers, signal conditioning circuits, drivers, inverters, timers and/or the like.

Torque controller 630 may optionally receive a feedback signal 628 reflective of generator current drawn from motor-generator 606, or of drive current supplied to the motor-generator. In some embodiments, motor-generator current feedback signal 628 may be provided by one or more current sensor(s) 626. In other embodiments, motor-generator circuit 608 may be designed to provide motor-generator current feedback signal 628 directly, i.e. without the need for separate current sensor(s) 626. In some embodiments, current sensor(s) 626 may detect, and/or motor-generator current feedback signal 628 may be reflective of, the current drawn from motor-generator 606 after rectification—i.e. generator current feedback signal 628 may be reflective of a DC generator current level.

In the illustrated embodiment, current controller 612 controls the motor-generator current based at least in part on a torque control signal 632 (which may also be referred to as a torque reference signal 632). For example, current controller 612 may attempt to cause the motor current of the motor-generator 606 to track torque control signal 632. In the illustrated embodiment, torque control signal 632 is generated by control logic 636 and may be indicative of a magnitude of the desired motor torque to be developed in motor-generator 606 and/or a magnitude of the desired motor current to be supplied to motor-generator 606. Control logic 636 may comprise one or more suitably configured central processing units (CPU), one or more microprocessors, one or more microcontrollers, one or more field-programmable gate arrays (FPGA), application-specific integrated circuits (ASIC), logic circuits, combinations thereof or any other suitable processing unit(s) comprising hardware and/or firmware and/or software capable of functioning as described herein. In some embodiments, control logic 636 may be implemented in the analog domain by a suitably designed analog control circuit.

A load circuit 616 provides the electrical connection between current controller 612 and load 618. Load circuit comprises an output 614 from current controller 612, which is electrically connected to load 618. Load circuit 616 may also comprise other circuit components not expressly shown, e.g. rectifying circuits, amplifiers, signal conditioning circuits, capacitors, super capacitors, rechargeable batteries and/or the like. Depending on the embodiment, load circuit 616 may be completely outside of the torque controller 630.

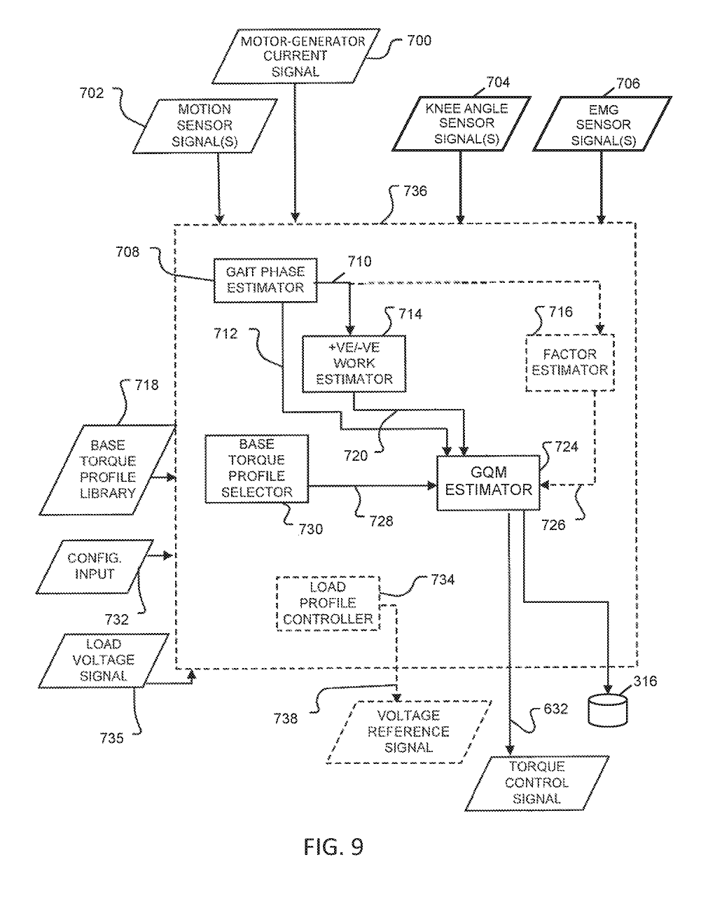

Referring to FIG. 9, control logic 736 is shown according to a particular embodiment. Control logic 736 may be used as, or as a part of, control logic 636 of rehabilitation system 602 (FIG. 7) and may be used to determine torque control signal 632 discussed above. In the illustrated embodiment, control logic 736 receives a number of inputs, which include: motion sensor signal(s) 702 (e.g. from motion sensor(s) 620) indicative of one or more aspects of the motion of body segments 600; EMG sensor signal(s) 706 (e.g. from EMG sensor(s) 625) indicative of one or more aspects of the muscle activity of body segment 600; motor-generator current signal 700 (e.g. from motor-generator current sensor(s) 702) indicative of the current output of or current input to motor-generator 606; joint angle sensor signal(s) 704 (e.g. from joint angle sensor(s) 624) indicative of the current joint angular position; a base torque profile library input 718; and a configuration input 732.

In the illustrated embodiment, where a knee joint connects body segments 600 and energy is applied thereto, control logic 736 comprises a gait phase estimator 708. Gait phase estimator 708 generates a gait phase estimate signal 710 indicative of the current phase of the gait of body segments 600. Gait phase estimator 708 may use information from motion sensor signal(s) 702 and/or EMG sensor signals 706 to generate its gait phase estimate signal 710. Motion sensor signal(s) 702 may comprise the three phase voltage output signals from motor-generator 606 which may be used to estimate the angular velocity of the motor-generator and the corresponding relative angular velocity of body segments 600. In some embodiments, gait phase estimator 708 may also make use of other inputs (e.g. motor-generator current feedback signal 700 or other inputs from other sensors) to generate its gait phase estimate signal 710. In some embodiments, gait phase estimator 708 may additionally or alternatively estimate whether the current gait phase is within one of the particular portions of a gait cycle which spans a range of gait phases, e.g. whether the knee joint is in swing flexion, swing extension, stance/collision flexion or stance extension. In one particular embodiment, gait phase estimator 708 may determine the transitions between gait phase portions and output information in gait phase estimate signal 710 indicating that a transition has occurred between gait portions.

Positive/negative work estimator 714 may make use of a variety of information to ascertain whether the motion of body segments 600 is in a positive or negative mechanical power mode. By way of non-limiting examples, such information may include gait phase estimate signal 710, motion sensor signal(s) 702, EMG sensor signal(s) 706, and/or motor-generator current feedback signal 700. In one particular non-limiting example, positive/negative work estimator 714 may use gait phase estimator signal 710 to determine the time of transitions between portions of a host's gait cycle.

Factor estimator 716 may make use of a variety of information to generate factor estimator output signal 726. Factors which may be estimated may be defined as every event or those which may have an impact on repetitive motion associated with the body segments, such as for example gait cadence, speed of movement, host, host-specific gait parameters, host size, load carried by the host, location of carried load or locomotion type. By way of non-limiting examples, information used to generate factor estimator output may include gait phase estimate signal 710, positive/negative power mode signal 720, motion sensor signal(s) 702 and/or motor-generator current feedback signal 700, and/or one or more other appropriate signals.

Control logic 736 may comprise a base torque profile selector 730 which serves the purpose of selecting a base torque profile 728 from a library 718 of base torque profiles. Base torque profile library 718 may comprise a library of base torque profiles for different types of repetitive motions, different types of gait problem and different severities of gait problem. The selection of a particular base torque profile 728 by base torque profile selector 730 may be based, in part, on configuration input 732. The configuration input 732 may comprise user-configurable input information about the pre-categorization of the patient, prior or intended use of the rehabilitation system 600, experimentally determined information about the use of other similar rehabilitation systems, calibration information of the rehabilitation system and its use, system constant information and/or the like.

Control logic 736 includes a GQM estimator 724, which calculates and stores the GQM in the database 316. The GQM estimator 724 may also adjust the settings of the assistance provided to the patient. For example, the GQM estimator 724 adjusts the base torque profile and/or a current torque profile in response to a variety of input information in order to provide (as output) torque control signal 632. GQM estimator 724 may receive input information which may include, without limitation: base torque profile 728, gait phase estimator output 712, positive/negative work estimator output 720, factor estimator output 726, configuration input 732, motion sensor signal(s) 702 and/or motor-generator current signal 700.

Control logic 736 comprises an optional load profile controller 734 which outputs a voltage control signal 738. Load profile controller 734 may use information from load voltage feedback signal 735 to generate voltage control signal 738. In some embodiments, load profile controller 734 may also make use of configuration input 732 and/or other inputs to generate voltage control signal 738. By way of non-limiting example, configuration input 732 may include parameters of load and/or parameters of generator 606.

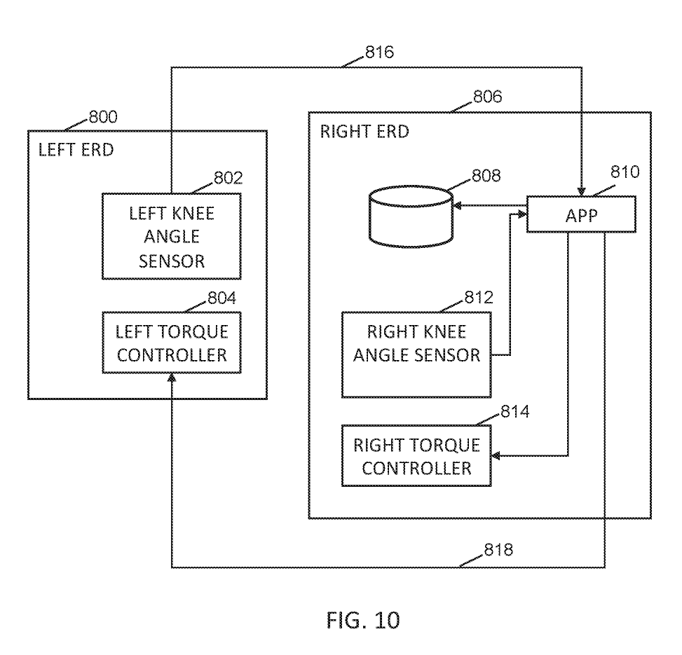

Referring to FIG. 10, a system of two ERDs is used for patient rehabilitation. The left ERD 800 comprises a left knee angle sensor 802 and a left torque controller 804. The right ERD 806 comprises a right knee angle sensor 812, a right torque controller 814 and an app or program software 810. The left and right ERDs together form an exoskeletal rehabilitation system (ERS). Data is communicated from both left knee angle sensor 802 via connection 816 and right knee angle sensor 812 to the program software 810, and then stored in the database 808. The app 810 processes the data and sends resulting control signals to the right torque controller 814 and, via connection 818, to the left torque controller 804 in order to implement the mechanical movements and resistance desired in the patient's rehabilitation plan. Connections 816 and 818 may be wired or wireless.

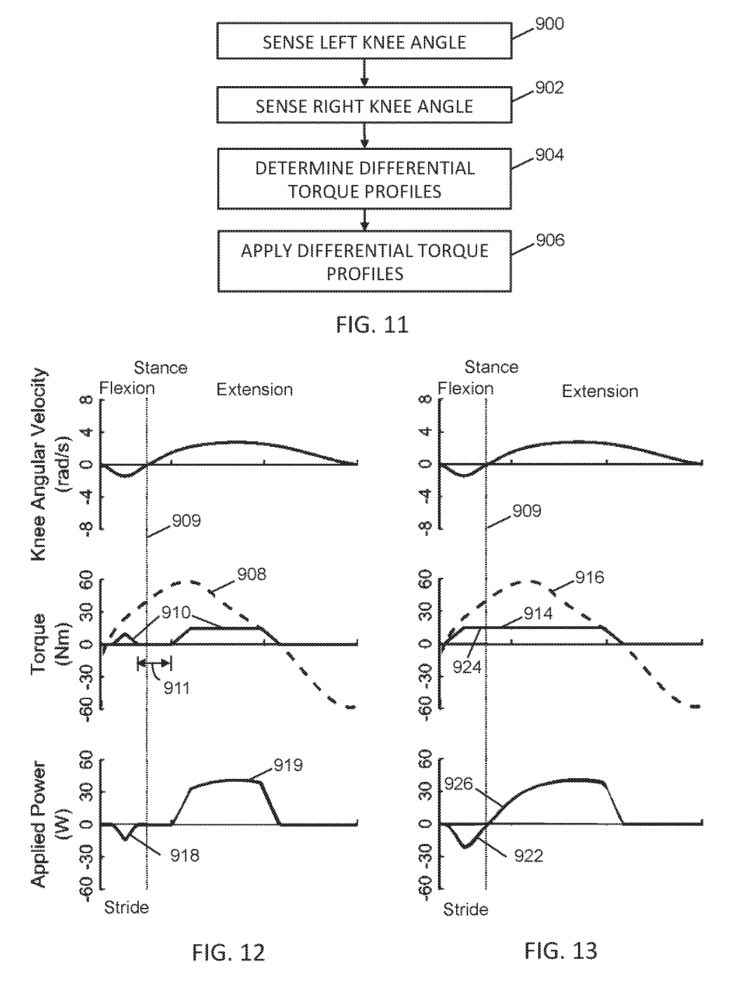

Referring to FIG. 11, the cooperation between two ERDs is described. In step 900, the left knee angle is detected and in step 902 the right knee angle is detected. This allows the ERS to determine, in step 904, the differential between the torque profiles that are required for each leg. The torque profiles are temporally offset from each other to correspond to alternating movements of the legs, and the torque profiles may also differ in amplitude and/or shape. In the next step 906, the different torque profiles are applied to each ERD with an offset of half a gait cycle (for example) between them. As a result, the cooperation between the two ERDs results in the gait assistance being highly adapted to the user's gait, by taking into account the specificities of the movement of each leg during the gait.

In one variation of the system, the control of the motor-generator speed is extended from control above a certain speed, (e.g. typically a knee angular velocity >1.5 rad/s), to control right down to very slow speeds (e.g. down to 0.15 rad/s). Referring to FIG. 12, there are shown graphs of knee angular velocity, torque and applied power during stance motion without slow speed motor-generator control. Trace 908 shows the torque of the knee during the stance flexion and stance extension. When the knee angular velocity changes its direction as the knee goes from flexion to extension, at line 909, the value of the applied torque 910 drops to zero over range 911. This is because the angular velocity of the knee joint is <1.5 rad/s, and, because the motor-generator cannot be controlled at such low speeds, no torque can be applied. The applied power is shown as peak 918 in the flexion phase and peak 919 in the extension phase.

Referring to FIG. 13, there are shown corresponding graphs of knee angular velocity, torque and applied power on the same scale during the same stance motion, but now with slow speed control. In this embodiment, the slow speed control is implemented in order to apply a torque during the transition between the knee flexion and extension, i.e. for knee angular velocities below 1.5 rad/s. Shown by line 914, the applied torque is consistent during the change between the flexion and the extension phases of the gait, while the measured knee torque 916 is the same as torque 908, FIG. 11. The applied power 922 in the negative power mode with slow speed control shows a greater amplitude and a larger width compared to the applied power 918 in the negative power mode without slow speed control. As a consequence, the amplitude of the applied torque 914 reaches a higher value 924 during the stance flexion phase, compared to the case without slow speed motor control. The applied power 926 in the extension phase is also seen to be greater than the case without the slow speed motor control. In addition, with the implementation of the slow speed control, after reaching a threshold during the stance flexion, the value of the applied torque value is kept constant while the user progresses through his stance from flexion to extension. The converse is true, in that torque is applied continuously as the patient progresses through his gait from extension to flexion.

Slow speed motor control is achieved by using a high accuracy sensor that feeds signals into a hybrid algorithm. At slow speeds, the sensor is used, and at high speeds, sensorless control is used.

### D. Variations

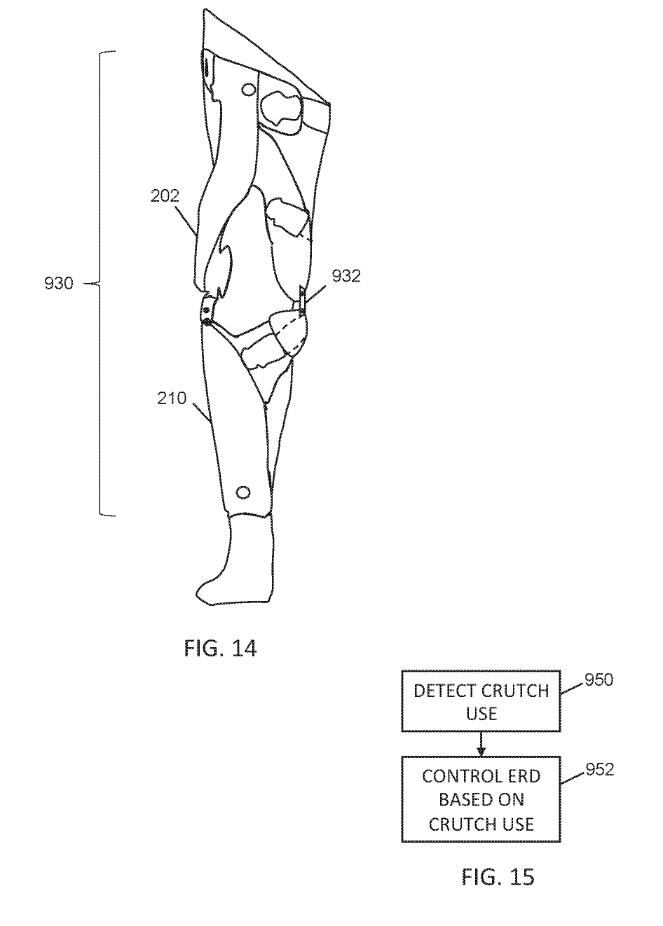

Referring to FIG. 14, a variation of the ERD 930 is shown with an additional medial or inside hinge 932 positioned on the left side of the right knee. The medial hinge 932 is connected to extensions of the upper shell 202 and the lower shell 210, and is a complex hinge. The additional hinge 932 is designed to stabilize the binding of the ERD 930 to the knee in situations where the device is prone to a twisting moment about the vertical axis when increased torque is applied at the side of the leg. This additional component is also implemented to mitigate the relative asymmetric arrangement of the device, in which all motion is harnessed or transmitted by one joint on the outer side of the knee. Moreover, adding a supplementary support on the inner side of the knee between the upper and lower leg segments may help to alleviate mechanical movement artifacts or twists resulting from the complexity of the human gait motion. The supplementary support, or hinge, is oriented in such a manner that durability of the ERD 930, effectiveness of coupling and power transfer during gait is improved. Depending on the embodiment, the hinge 932 may be simple or complex. The hinge may be a simple single pivot, or include multiple pivots, and may be constructed using low profile flexible materials so that mobility is not impeded.

Structural modifications may be added to the ERD in order to increase the surface area of lower shell, the upper shell, or both, for the purpose of minimizing and spreading the impact of the pressure on the leg. Moreover, this increased surface area reduces the movement of the ERD relative to the leg.

In an alternative embodiment, the upper anchor point is extended to the hip. The lever arm embodied by the upper subshell is extended a little further, for reducing forces and allowing attachment to a less fleshy location on the body. In some embodiments, the connection is made to a hip belt. In other embodiments, the upper subshell is connected via another joint to the hip.

A knee pad may be used and made from various lightweight materials in order to facilitate the attachment and the fixation of the ERD to the knee. In addition to that, a battery or motor-generator may be included in the knee pad in order to collect generated energy.

In other embodiments, a rigid attachment from either the upper or lower shell of the ERD to a kneepad allows for the transfer of force and consequently moves the attachment to an alternate point for coupling torque. The attachment is held in place with a detachable strap connected to the back part of the knee pad.

In an alternative embodiment, a second motor/generator is set up to operate via the additional hinge located on the inner side of the knee. A specific response may be calculated and optimized by the software 810 for implementing torque application on this additional hinge, in order to optimize adjustment of the gait assistance.

In an alternative embodiment, implementation of artificial intelligence is used in order to determine the torque to be applied. A gait phase state machine helps to synchronize the user's gait with the torque profile desired by the therapist. Torque can be adjusted in three scenarios: firstly, to increase the amount of assistance in order to increase the patient's mobility; secondly, to maintain the current level of assistance in order for the patients to push themselves further or maintain current mobility; and thirdly, to reduce the level of assistance also in order for the patients to push themselves further.

The system may detect the use of crutches and adapt its assistance to the user's gait. For example, in some embodiments there are various settings: with crutches and strong assistance; with crutches and light assistance; without crutches and with strong assistance; and without crutches and with light assistance. The settings can be worked through by the patient as a progression from easy to hard. Settings could be selected manually, or they could be selected automatically, depending on the embodiment. Referring to FIG. 15, the use of the crutches is detected in step 950. This is determined from the gait characteristics obtained through the sensors 620. In step 952, the motor-generator of the ERD is controlled based on whether or not the patient is using crutches.

The system may include an accelerometer. As a consequence of including the accelerometer, rapid acceleration is detected and additional resistance added in response, if required. In this embodiment, Segway™-style gyroscopes are required such as vibrating structure gyroscopes or inclinometers.

The system may include an accelerometer with a Wi-Fi/Bluetooth™/Sim communication medium as an option for when the patient is wearing the device outside of a supervised environment. As a consequence, data about the patient's movement can be transmitted to a therapist.

Use of a 3D printer to size the device to a young patient allows components to be exchanged inexpensively as the user grows; to put it another way, besides the implementation of a personalized gait-assistance by making use of user data collection, the ERD may be specifically tailored to the anatomy of the user.

In other embodiments, the minimum number of gait cycles used to determine the baseline gait measurements may be other than three.

The foregoing embodiments and aspects thereof are described and illustrated in conjunction with systems, tools and methods that are intended to be exemplary and illustrative, and not limiting in scope.

1. A device for rehabilitating a patient with a gait disorder, comprising:
a motor-generator linked between a thigh and a shin of the patient, the thigh and shin connected by a knee;
a knee angle sensor configured to detect angles of the knee;
a computer readable memory configured to store detected knee angles; and
a control module configured to control the motor-generator based on:
an initial maximum extension of the knee detected at a start of rehabilitation; and
a torque profile corresponding to the gait disorder.

2. The device of claim 1, further comprising:
an upper shell that conforms to the thigh;
a lower shell that conforms to the shin; and
a simple or complex lateral hinge between the upper shell and the lower shell.

3. The device of claim 2, further comprising a simple or complex medial hinge between the upper shell and the lower shell.

4. The device of claim 2, further comprising a kneepad rigidly attached to either the upper shell or the lower shell.

5. The device of claim 2, wherein the upper shell is connectable to a hip of the patient via a joint or a belt worn by the patient.

6. The device of claim 2, wherein the upper and lower shells are removable and replaceable by upper and lower shells of a different size.

7. The device of claim 2, further comprising an electromyography sensor configured to detect a spasm in a muscle of the patient, wherein the control module is configured to control the motor-generator based on detection of the spasm.

8. The device of claim 1, wherein the motor-generator:
provides augmentation to movement between the thigh and the shin during positive work phases of the patient's gait;
provides resistance to movement between the thigh and the shin during negative work phases of the patient's gait; and
applies torque to the thigh and shin continuously as the gait changes phase between flexion and extension.

9. The device of claim 1, wherein the initial maximum extension is an average maximum extension over at least a plurality of cycles of the patient's gait and the control module is configured to:
determine a later maximum extension of the knee after a period of rehabilitation, wherein the later maximum extension is an average maximum extension over at least a second plurality of cycles of the patient's gait; and
adapt operation of the motor-generator to the later maximum extension.

10. The device of claim 9, wherein the adaption to the later maximum extension is performed automatically.

11. The device of claim 1, further comprising:
a motion sensor; and
a gait quality estimator configured to calculate a gait quality measure (GQM) using inputs from the knee angle sensor and the motion sensor;
wherein the control module is configured to monitor the GQM throughout the rehabilitation.

12. The device of claim 11, wherein the torque profile is modified based on signals generated by the motion sensor and the knee angle sensor.

13. A system for rehabilitating a patient with a gait disorder, comprising:
a left device comprising:
a motor-generator linked between a left thigh and a left shin of the patient, the left thigh and left shin connected by a left knee; and
a left knee angle sensor configured to detect angles of the left knee;
a right device comprising:
a motor-generator linked between a right thigh and a right shin of the patient, the right thigh and right shin connected by a right knee; and
a right knee angle sensor configured to detect angles of the right knee;
a computer readable memory configured to store detected left knee angles and detected right knee angles;
a left control module configured to control the left motor-generator based on:
an initial maximum extension of the left knee detected at a start of rehabilitation; and
a left torque profile corresponding to the gait disorder; and
a right control module configured to control the right motor-generator based on:
an initial maximum extension of the right knee detected at a start of rehabilitation; and
a right torque profile corresponding to the gait disorder;

14. A method for rehabilitating a patient with a gait disorder, comprising:
attaching, to the patient, a motor-generator between a thigh and a shin of the patient, the thigh and shin connected by a knee;
detecting, with a knee angle sensor, an initial maximum extension of the knee at a start of rehabilitation;
controlling the motor-generator based on:
the initial maximum knee extension; and
a torque profile corresponding to the gait disorder; and
storing, during a period of rehabilitation, detected knee angles in a computer readable memory.

15. The method of claim 14, further comprising:
augmenting, with the motor-generator, movement between the thigh and the shin during positive work phases of the patient's gait;
opposing, by the motor-generator, movement between the thigh and the shin during negative work phases of the patient's gait.
applying, by the motor-generator, torque to the thigh and shin continuously as the gait changes phase between flexion and extension.

16. The method of claim 14, further comprising:
calculating the initial maximum extension to be an average maximum extension over at least a plurality of cycles of the patient's gait;
determining, by the control module, a later maximum extension of the knee after a period of rehabilitation, wherein the later maximum extension is an average maximum extension over at least a second plurality of cycles of the patient's gait; and
adapting operation of the motor-generator to the later maximum extension.

17. The method of claim 14, further comprising:
calculating, by the control module, a gait quality measure (GQM) using inputs from the knee angle sensor and a motion sensor; and
monitoring, by the control module, the GQM throughout the rehabilitation.

18. The method of claim 14, further comprising:
modifying the torque profile based on signals generated by a motion sensor and the knee angle sensor.

19. The method of claim 14, further comprising:
attaching, to the patient, a further motor-generator between another thigh and another shin of the patient, the other thigh and other shin connected by another knee;
detecting, with another knee angle sensor, an initial maximum extension of the other knee at a start of rehabilitation;
controlling the further motor-generator based on:
the initial maximum knee extension of the other knee; and
the further torque profile corresponding to the gait disorder; and
storing, during a period of rehabilitation, detected angles of the other knee in the computer readable memory.

20. The method of claim 14 comprising:
automatically detecting whether the patient is using crutches; and
controlling the motor-generator based on whether the patient is using crutches.
